(19) United States
(12) Patent Application Publication
(10) Pub. No.: US 2006/0269251 A1
(43) Pub. Date: Nov. 30, 2006

(54) Body exercise A/V player controller

(76) Inventor: Wei Hsu, Taipei Hsien (TW)

Correspondence Address: WEI HSU, 235 Chung-Ho, Box 8-24, Taipei, TW

(21) Appl. No.: 11/135,552

(22) Filed: May 24, 2005

(51) Int. Cl. H04N 7/00

(52) U.S. Cl. 386/96

(57) ABSTRACT

A body exercise A/V player controller comprises an audio/video (A/V) input units capable of being connected to various A/V players; at least one sensor unit for sensing the exercise level of an user; a signal converting unit for converting sensing signals from the at least one sensor into signals matching to the requirement of a control circuit; and a control circuit for comparing the signals inputted into the control circuit with setting values so as to change output signals to an A./V player so that the output signals are varied with the sensed signals. The controller further comprises a main control circuit, an input selection and speed adjusting circuit, a signal processing circuit, a signal generator, a power supply unit, a game machine converting circuit, an input signal switch, a processing circuit, a high frequency decaying circuit and a statue indication circuit.

### FIELD OF THE INVENTION

The present invention relates to exercise machines, and particularly to a body exercise A/V player controller used in an exercise machine which can inspire the users to exercise willingly and effectively so as to improve the health of the users.

### BACKGROUND OF THE INVENTION

Currently people seldom exercises, especially those worked by brains. More and more people are lack of exercise so as to affect the health of the bodies. In general, the experts consider that twice exercises to make the pulse achieve a value of 90 per minute and expand the size of the blood vessels are necessary every day. If the exercise time period is just a few minutes, it is unhelpful to health.

However currently, the space is too narrow to provide a sufficient space for people to make exercise. Thus some home or office used exercise training machines are developed, but these machines are dull and cannot inspire users to use the machines willingly. Thereby there is an eager demand for a novel exercise machine which can improve the defect in the prior art.

### SUMMARY OF THE INVENTION

Accordingly, the primary object of the present invention is to provide a body exercise A/V player controller used in an exercise machined which can inspire the users to exercise willingly and effectively so as to improve the health of the users. To achieve above object, the present invention provides a body exercise A/V player controller. The controller comprises an audio/video (A/V) input units capable of being connected to various A/V players; at least one sensor unit for sensing the exercise level of an user; a signal converting unit for converting sensing signals from the at least one sensor into signals matching to the requirement of a control circuit; and a control circuit for comparing the signals inputted into the control circuit with setting values so as to change output signals to an A./V player so that the output signals are varied with the sensed signals. The controller further comprises a main control circuit, an input selection and speed adjusting circuit, a signal processing circuit, a signal generator, a power supply unit, a game machine converting circuit, an input signal switch, a processing circuit, a high frequency decaying circuit and a statue indication circuit.

Moreover, the present invention provides a main control circuit 30 serves for determining the signal strength in unit time period so as to control an output of a high frequency decaying circuit 38. The stronger the signal strength, the smaller the decay of the output signal. The main control circuit 30 determines the kind of the input signals working now according to the status of the switches so as to light up a corresponding indicator light PL 15 and enable a correct circuit. An input selection and speed adjusting circuit serves to transfer external setting values to the main control circuit. A signal processing circuit serves to amplify the signal inputted from a sensor to a desired level. A signal generator serves for triggering wireless signals in a fixed time period and then emitting the signals to external exercise machines. A power supply unit serves for supplying power to the controller. A game machine converting circuit serves for correctly connecting a main control circuit and determining a game machine. An input signal switching and processing circuit serves for switching the input signals of the compact disk player and the game machine and processing the signals to match the specification of TVs (televisions). A high frequency decaying circuit serves to convert the exercise speed signals from the exercise machines into respective control signals through the main control circuit for controlling the decay of the signals. The variation of the exercise speed is inversely proportional to the decay of the signals. The quicker the exercise, the smaller the decay, and vice versa. An statue indication circuit receives the input signals of the switch status and the installation status from the main control circuit so as to light up respective indicator lights.

The body exercise A/V player controller further comprises an input selection and speed adjusting circuit in the control circuit; a CD player input terminal for connecting the A./V player to the input selection and speed adjusting circuit; four game machine receptacles for connecting with different game machines, a wired and wireless TV (television) signal input terminal for connecting the control circuit to a coaxial cable of a wired or wireless TV.

Moreover, a set top box is connected to the game machine converting circuit and the main control circuit through cables; the set top box is installed with detecting and converting circuit for converting variation of exercise into resistance and then the variation is inputted into pins of a game machine control IC; the set top box is connected to a game machine converting circuit and the main control circuit so that the main control circuit can connect with different game machine and light up a predetermined indicator light.

The various objects and advantages of the present invention will be more readily understood from the following detailed description when read in conjunction with the appended drawing.

### BRIEF DESCRIPTION OF THE DRAWINGS

FIG. 1 shows the structure of one embodiment of the present invention.

FIG. 2 shows the interior circuit of the embodiment of the present invention.

FIG. 3 shows the circuit flow diagram of another embodiment of the present invention.

FIG. 4 shows the circuit flow diagram of a further embodiment of the present invention.

FIG. 5 shows the circuit flow diagram of a yet embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

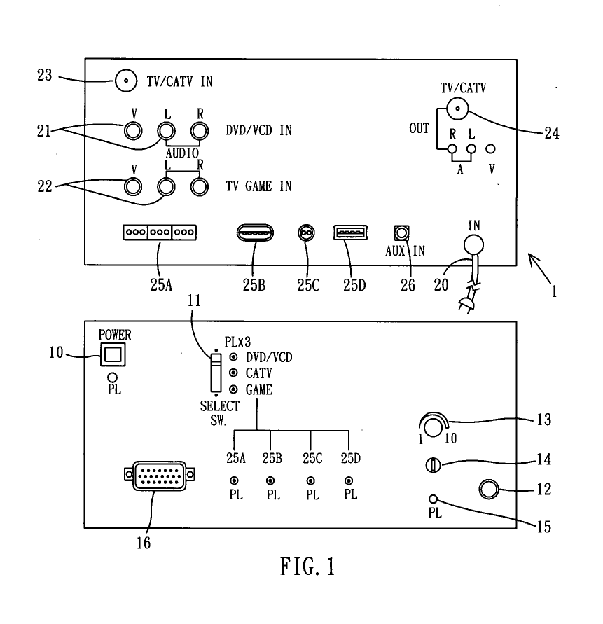

Referring to FIG. 1, the body exercise A/V player controller of the present invention is illustrated. The present invention serves to connect to external devices, such as a CD player 5, a game machine 6, and a wired or wireless TV program 7; to select a desired game and to display on a display 8. The controller 1 has a casing. A front panel of the controller 1 has a power switch 10, a selected switch 11, a trigger signal outlet 12, an adjusting button 13, a sensor button 14 and a plurality of indicator lights PL 15 formed by a plurality of LEDs corresponding to various functions; a cable connecting receptacle 16 to be connected to a set top box 60. A back side of the controller 1 is used to be connected to external audio/video (A/V) playing devices, including a power wire 20, a CD player input terminal 21, a game machine input terminal 22, a wired and wireless TV signal input terminal 23, a common output terminal 24, four game machine receptacles A, B, C and D; and a sensor input terminal 26.

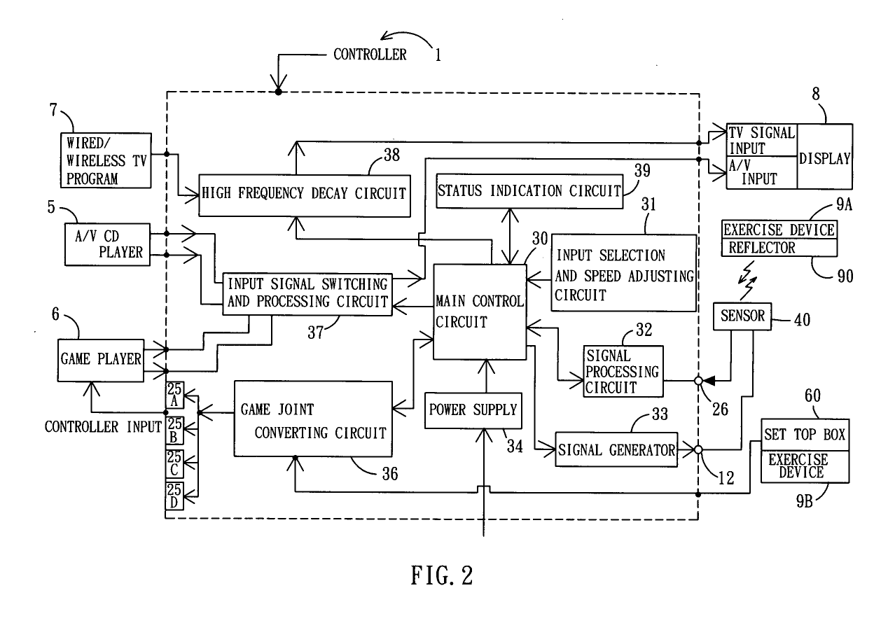

As shown in FIG. 2, the internal structure of the body exercise A/V player controller of the present invention is illustrated.

A main control circuit 30 serves for determining the signal strength in unit time period so as to control an output of a high frequency decaying circuit 38. The stronger the signal strength, the smaller the decay of the output signal. The main control circuit 30 determines the kind of the input signals working now according to the status of the switches so as to light up a corresponding indicator light PL 15 and enable a correct circuit.

An input selection and speed adjusting circuit 31 serves to transfer external setting values to the main control circuit 30.

A signal processing circuit 32 serves to amplify the signal inputted from a sensor to a desired level.

A signal generator 33 serves for triggering wireless signals in a fixed time period and then emitting the signals to external exercise machines 9A and 9B.

A power supply unit 34 serves for supplying power to the controller 1.

A game machine converting circuit 36 serves for correctly connecting a main control circuit 30 and determining a game machine 6.

An input signal switching and processing circuit 37 serves for switching the input signals of the compact disk player 5 and the game machine 6 and processing the signals to match the specification of TVs (televisions).

A high frequency decaying circuit 38 serves to convert the exercise speed signals from the exercise machines 9A, 9B into respective control signals through the main control circuit 30 for controlling the decay of the signals. The variation of the exercise speed is inversely proportional to the decay of the signals. The quicker the exercise, the smaller the decay, and vice versa.

A statue indication circuit 39 receives the input signals of the switch status and the installation status from the main control circuit 30 so as to light up respective indicator lights PL 15.

Furthermore, from above assembly, the input signals (pulses or voltage) from the sensor 40 for detecting the exercise is changed to desired signals (resistance). The signals are transferred to the main control circuit 30. The main control circuit 30 serves to control the output signals to a desired level according to the setting of the external buttons, signals from the high frequency decaying circuit 38 and input signal switching and processing circuit 37.

Oneoperation of the present invention will be described herein.

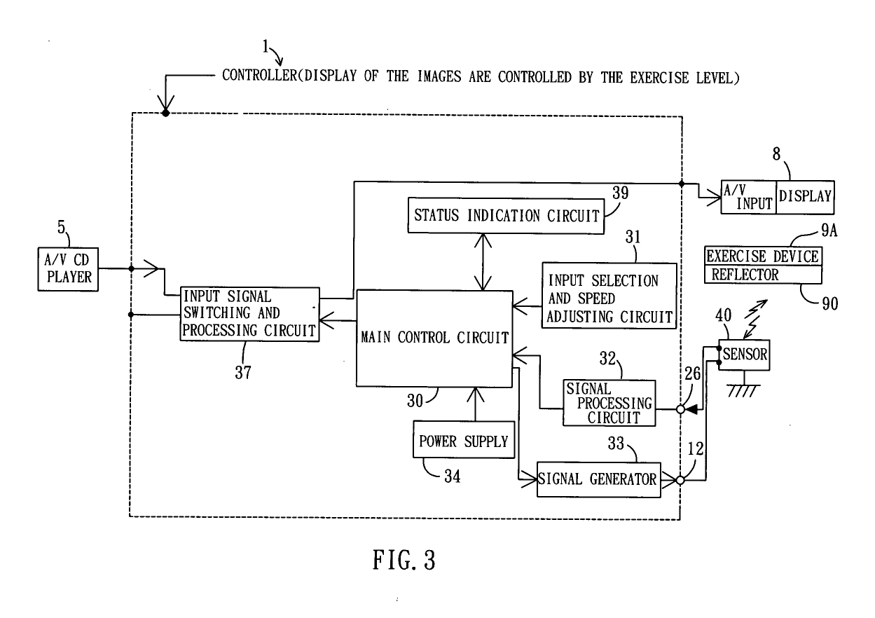

Referring to FIG. 3, the user exercise by an exercise machine 9A (for example, hula hoop) and see images displayed by the compact disk player 5. The exercise machine 9A is installed with a reflector 90. A sensor 40 is placed in a predetermined distance from the exercise machine 9A. The sensor 40 is connected to a sensor input terminal 26 of the controller 1 through wires. Then the A/V outputs of the compact disk player 5 are transferred to the CD player input terminal 21 of the controller 1. Then the common output terminal 24 of the controller 1 is connected to the display 8. The powers of the controller 1, compact disk player 5, display 8, etc. are actuated. Then the user sets a selection item 11 so that the display item is set as CD display. The setting of the adjusting button 13 is set according to the exercise speed of the user. Furthermore, the illumination of the display 8 is controlled by the controller 1. In exercise, the exercise level of the user will be sensed by the sensor 40. Furthermore, the rotating time period of the exercise machine 9A is transferred to the game machine input terminal 22 by pulses, which is compared with setting values. Once it is lower than the setting value, the input signal switching and processing circuit 37 will be triggered so that the voltage of the signals are changed, which is then outputted through the common output terminal 24 of the controller 1. The signals are then transferred to the display 8 so that the display images become dark and emitting sounds becomes smaller. If the exercise restores to a normal valve, the images and sounds are restored to normal conditions.

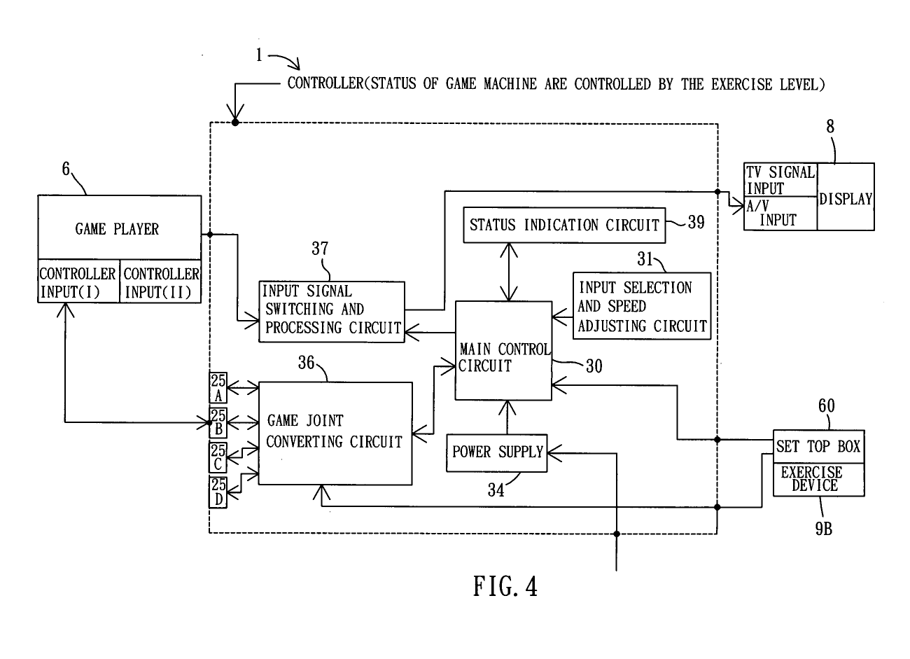

Referring to FIG. 4, the exercise machine 9B (bicycle) is used with the game machine 6. The sensor is installed to the exercise machine 9B. The outputs of the sensor are transferred to the set top box 60. The set top box 60 has a control integrated circuit (IC) controlling a plurality of handles for controlling various game machines 6. The set top box 60 is connected to the game machine converting circuit 36 and the main control circuit 30 through cables. When the powers of the main control circuit 30 and the game machine 36 are actuated, the detected signals are compared with setting values according to the defaults of the selected switch 11 and the set top box 60 (for example, to switching the window of the left or right rear viewing lights or single player or two players, etc.). This setting can be achieved by the buttons on the set top box 60. Finally, the outputs of the game machine 6 are connected to the display 8. After completing above actions, the original actions performed by the set top box 60 are replaced by the circuit of the converting circuit. Thus, in use, when the user treads the bicycle, the sensor will sense the exercise level through the sensor. The pulses representing the rotation speeds of the wheel are transferred and are compared with the setting values. When the treading speed is slower, the signals will be lower than the setting values. The signals will be transferred into resistances which are then transferred to pins of the IC representing the level of the throttle. Then the IC outputs signal package matching to the protocol of the game machine according to the resistance. The package is transferred to the game machine converting circuit 36. Then it is transferred to the game machine 6 to control the game machine 6.

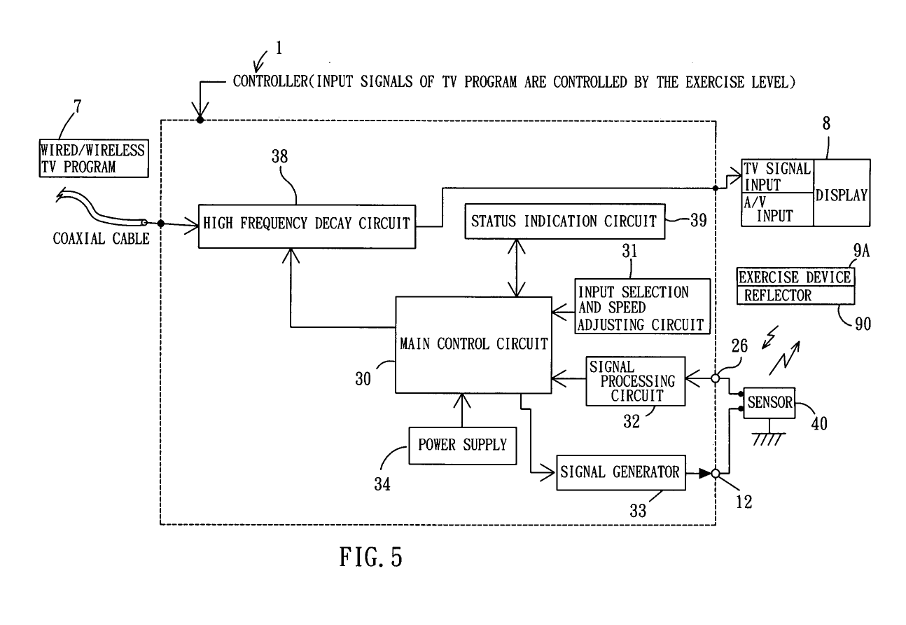

Referring to FIG. 5, it is similar to FIG. 3, in this the present invention, the controller 1 senses the exercise level of the senor 40. Then signals are transferred to the main control circuit 30 for comparing with the setting values. If it is lower than the setting value, the high frequency decaying circuit 38 is triggered so that output signal is weakened. When the signal is inputted into the display 8, the display image becomes weaker and the sound is distorted. When the exercise is adjusted to a normal state, the display status of the display will restore to the normal state.

Similarly, the variations of the exercising portions of the user can be detected by various sensors installed at those exercising portions as the manual control functions of the game machine. The variation signals are transferred to different pins of the IC. The exercise machines 9A, 9B may be for example, a hula hoop exercise, rope skipping, or operating an exercise bicycle, a running machine, an arm training machine etc. which can be selected to combine with the controller 1.

Besides, in the present invention, a plurality of game machines can be used with a plurality of controllers 1, or a plurality of controllers 1 are connected to a game machine 6. Thereby many persons can exercise at the same time and play the games in the game machine at the same time. Thereby the users can inspire one another so as to increase the exercising efficiency.

Furthermore, the present invention can be used through Internet so that the same controllers and same exercise machines can be used through the connection of the Internet. Thus many persons can play the games in far places.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A body exercise A/V player controller comprising:
an audio/video (A/V) input units capable of being connected to various A/V players;
at least one sensor unit for sensing an quality related to the exercise of an user;
a signal converting unit for converting sensing signals from the at least one sensor into signals matching to the requirement of a control circuit; and
a control circuit for comparing the signals inputted into the control circuit with setting values so as to change output signals to an A./V player so that the output signals are varied with the sensed signals.

2. The body exercise A/V player controller as claimed in claim 1, further comprising
an input selection and speed adjusting circuit in the control circuit; a CD player input terminal for connecting the A./V player to the input selection and speed adjusting circuit.

3. The body exercise A/V player controller as claimed in claim 1, further comprising four game machine receptacles for connecting with different game machines.

4. The body exercise A/V player controller as claimed in claim 1, further comprising a wired and wireless TV (television) signal input terminal for connecting the control circuit to a coaxial cable of a wired or wireless TV.

5. The body exercise A/V player controller as claimed in claim 1, wherein the sensor serves to receive wireless signals from the controller and sense signals from actions of an exercise machine.

6. The body exercise A/V player controller as claimed in claim 1, further comprising a main control circuit, an input selection and speed adjusting circuit, a signal processing circuit, a signal generator, a power supply unit, a game machine converting circuit, an input signal switch, a processing circuit, a high frequency decaying circuit and a statue indication circuit.

7. The body exercise A/V player controller as claimed in claim 6, wherein the main control circuit serves for determining the signal strength in unit time period so as to control an output of a high frequency decaying circuit; the stronger the signal strength, the smaller the decay of the output signal; and the main control circuit determines the kind of the input signals working now according to the status of the switches so as to light up a corresponding indicator light and enable a correct circuit.

8. The body exercise A/V player controller as claimed in claim 7, wherein the high frequency decaying circuit serve s to convert the exercise speed signals from exercise machines into respective control signals through the main control circuit for controlling the decay of the signals; the variation of the exercise speed is inversely proportional to the decay of the signals.

9. The body exercise A/V player controller as claimed in claim 8, wherein an input selection and speed adjusting circuit serves to transfer external setting values to the main control circuit.

10. The body exercise A/V player controller as claimed in claim 9, wherein the signal processing circuit serves to amplify the signal inputted from a sensor to a desired level.

11. The body exercise A/V player controller as claimed in claim 10, wherein the signal generator serves for triggering wireless signals in a fixed time period and then emitting the signals to external exercise machines.

12. The body exercise A/V player controller as claimed in claim 11, wherein the power supply unit serves for supplying power to the controller.

13. The body exercise A/V player controller as claimed in claim 12, wherein the game machine converting circuit serves for correctly connecting a main control circuit and determining a game machine.

14. The body exercise A/V player controller as claimed in claim 13, wherein an input signal switching and processing circuit serves for switching the input signals of the compact disk player and the game machine and processing the signals to match the specification of TVs (televisions).

15. The body exercise A/V player controller as claimed in claim 14, wherein the statue indication circuit receives the input signals of the switch status and the installation status from the main control circuit so as to light up respective indicator lights.

16. The body exercise A/V player controller as claimed in claim 6, wherein a set top box is connected to the game machine converting circuit and the main control circuit through cables; the set top box is installed with detecting and converting circuit for converting variation of exercise into resistance and then the variation is inputted into pins of a game machine control IC; the set top box is connected to a game machine converting circuit and the main control circuit so that the main control circuit can connect with different game machine and light up a predetermined indicator light.

17. The body exercise A/V player controller as claimed in claim 1, wherein the controller is connected with another control through network.
